(19) United States
(12) Patent Application Publication
(10) Pub. No.: US 2005/0251388 A1
(43) Pub. Date: Nov. 10, 2005

(54) Spectrogram reconstruction by means of a codebook

(75) Inventors: Mathias Lang, Eindhoven (NL); Cornelis Pieter Janse, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/526,196

(22) PCT Filed: Oct. 8, 2003
(86) PCT No.: PCT/IB03/04475

§ 371 Date: Mar. 1, 2005

(30) Foreign Application Priority Data
Nov. 5, 2002 (EP) 02079611.6

(51) Int. Cl. G10L 21/02

(52) U.S. Cl. 704/226

(57) ABSTRACT

A method for reconstructing a data spectrogram disturbed by noise and/or echo is described, wherein spectrogram data is subjected to an awarding of a reliability measure, and wherein the spectrogram data having a low reliability measure is replace by more reliable data. In particular the replacement is carried out by employing spectrogram data having a higher reliability measure as a means for selecting a code-book entry where said more reliable data is stored. Such a code-book is easy to implement, and this method avoids correlation calculations, inversions of matrices and limitations as to the specific types of used statistical models. The reconstruction method improves speech recognition results, which is important for voice controlled devices.

The present invention relates to a method for reconstructing a disturbed spectrogram comprising spectrogram data, which is subjected to an awarding of a reliability measure, and whereof the spectrogram data having a low reliability measure is replaced by more reliable data.

The present invention also relates to a device for implementing the above method, the device comprising means for subjecting the spectrogram data to an awarding of a reliability measure, and means for replacing the spectrogram data having a low reliability measure by more reliable data; and relates to signals suited for applying the method in the device concerned.

Such a method is known from an article, entitled “Introduction of a Reliability Measure in Missing Data Approach for Robust Speech Recognition”, by Ph. Renevey and A. Drygajlo, published in Proceedings of the 10th European Signal Processing Conference (EUSIPCO 2000), Tampere, Finland, Sep. 5-8, 2000, pp 473-476. The known method proposes the awarding of a probabilistic reliability measure ranging between zero and one to noisy disturbed data in a speech spectrogram. The signal to noise ratio provides information on the relative importance of both noise and signal and is suited to detect reliable and unreliable data spectrogram regions. Unreliable spectrogram data is replaced by an estimation of the unreliable data based on time independent Gaussian mixture models.

It is a disadvantage of the known method that computations as to the Gaussian mixture models provide a limited accuracy, due to the fact that for example speech spectrograms do not always behave in accordance with a Gaussian model.

Therefore it is an object of the present invention to provide a less costly, easy to implement and more accurate method and device for improved reconstruction of disturbed spectrograms, without the use of the Gaussian model.

Thereto the method according to the invention is characterized in that the replacement is carried out by employing spectrogram data having a higher reliability measure as a means for selecting a code-book entry where said more reliable data is stored.

Similarly the device according to the invention is characterized in that the device further comprises code-book means coupled to both the subjecting means and the replacing means for carrying out the replacement by employing spectrogram data having a higher reliability measure as a means for selecting a code-book entry where said more reliable data is stored.

It is an advantage of the method and device according to the present invention that the code-book acts as an easy to implement lookup table. Prior to the actual reconstruction the code-book is filled with entries where the generally more reliable data is stored, which data forms a priori information with respect to disturbed data. The spectrogram data having a higher reliability measure is used to select an entry where the reliable a priori information is present in order to replace the spectrogram data having a low reliability measure by the more reliable data stored in the code-book.

Further advantageously the method and device according to the invention avoid correlation calculations, inversions of matrices and limitations as to the specific types of used statistical models.

An embodiment of the method according to the invention is characterized that the selection of the code-book entry is based on a match between the spectrogram data H having a higher reliability measure and reliable spectrogram data H′ stored in the code-book.

In this case the code-book both may comprise the reliable spectrogram data H′ and reliable spectrogram data M. If the data H′ stored in the code-book closely matches the spectrogram data H having a higher reliability measure, then the data M is being used for substituting the spectrogram data L having a low reliability measure. The final result then is the highly reliable data H or possibly H′ and the improved higher reliable data M, which final result may be used for reconstruction of mostly speech.

A further embodiment of the method according to the invention is characterized in that the replacement is a gradual replacement.

Such a gradual replacement combines the spectrogram data (L) and the more reliable data (M) in a flexible weighted way. The combination is then outputted by the algorithm concerned.

A still further embodiment of the method cording to the invention is characterized in that the gradual replacement dependents on the reliability measure.

In that case the combination of data (L) and (M) is weighted in dependence on the reliability measure.

In a still further embodiment of the method according to the invention the spectrogram data stored in the code-book comprises data (H′, M) derived from training.

The filling of the code-book by means of a prior training session is very easy to accomplish, and will lead to undistorted “clean” code-book data.

Another further embodiment of the method according to the invention is characterized in that the disturbed spectrogram is disturbed with noise, in particular additive noise such as background noise, and/or acoustic echo.

Advantageously the above method may be used in a noisy environment such as present in for example a car.

Still another embodiment of the method according to the invention is characterized in that the finally output reliable data is influenced in dependence on known information on its time and/or frequency behavior.

The known information will generally be a priori information or information derived on a real time basis. The information provides additional flexibility and promotes the reconstruction true to nature of for example speech spectrograms.

A still further improved embodiment of the method according to the invention is characterized in that the disturbed spectrogram is the result of a spectral subtraction process wherein estimated or measured disturbance is subtracted from an original disturbed signal.

By including spectral subtraction and applying it in order to improve the amount of disturbance in the disturbed spectrogram data prior to subjecting this data to the awarding of the reliability measure and the carrying out of the replacement the reconstruction can be improved even further.

At present the method and device according to the invention will be elucidated further together with their additional advantages, while reference is being made to the appended drawing, wherein similar components are being referred to by means of the same reference numerals. In the drawing:

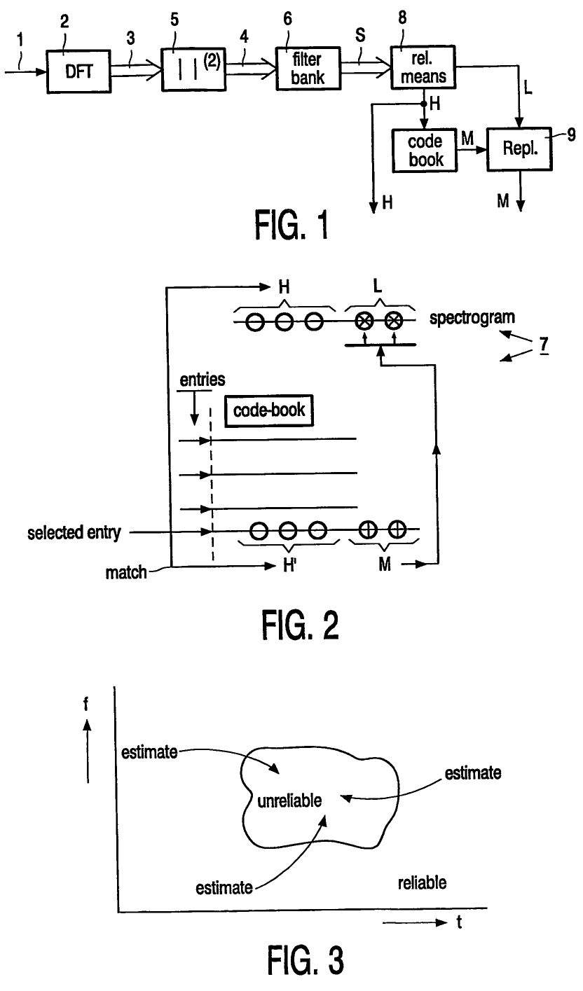

FIG. 1 shows a general outline of the steps to be taken in a device for implementing the method according to the present invention for reconstructing a disturbed spectrogram;

FIG. 2 shows a very simple scheme for explaining the basic operation of the method and device according to the invention; and

FIG. 3 shows a possible frequency versus time graph indicating an unreliable area having unreliable data, which can be estimated from data originating from a reliable area for the purpose of spectrogram reconstruction.

FIG. 1 shows a general outline of the functional steps to be taken in a device D concerning a method for the reconstruction of disturbed data, such as for example disturbed data in a spectrogram. Such a reconstruction is important in speech or voice recognition systems, such as for speech or voice control applications. The disturbance may for example be in the form of noise, in particular additive noise, such as may arise in a vehicle. Another example of disturbance is echo, in particular acoustic echo. A disturbed and generally windowed input signal shown in the device D of FIG. 1 is subjected at an input 1 to a spectral domain analysis by for example a Discrete Fourier Transform (DFT) filter bank 2, where after the phase of the output signal on output 3 thereof may be neglected to reveal for example the power spectrum, squared amplitude spectrum or the like at output 4 of absolute value unit 5. In many cases only the magnitudes of the frequency spectra are of interest. To the time dependent frequency magnitude spectrum will hereinafter be referred to as a spectrogram. It is common to most speech reconstruction or speech recognition systems to apply a MEL scale filter bank 6 after the DFT to obtain frequency domain outputs with a frequency spacing which is linear on a MEL scale in order to reduce the frequency resolution. If used without filter bank 6 the device D can be applied for speech enhancement independent from a speech recognizer. However in that case a large quantity of frequency data has to be processes. If the input signal on input 1 is disturbed, then data in the spectrograms S will be disturbed as well. Some data regions in the spectrogram are however more distorted or disturbed than others. The present reconstruction method replaces more disturbed and thus less reliable spectrogram data by more reliable data.

From a code-book 7 such more reliable data is available. Such a code-book may be filled with speech data in a way known per se. One technique to derive representative speech vectors is disclosed in an article entitled: “An Algorithm for Vector Quantizer Design”, by Y. Linde, A. Buzo, and R. M. Gray, published in: IEEE Transactions on Communications, Vol. 28. No. 1, pp 84-95, January 1980. The code-book 7 comprises data derived from training, generally less disturbed or possibly undisturbed, that is “clean” data. After allowing means 8 to award a reliability measure to spectrogram data which are input to the means 8 further means 9 replace the spectrogram data L having a low reliability measure by more reliable data M selected from the code-book 7. The selection is performed such that spectrogram data H having a higher reliability measure is being used as a means or pointer for selecting an entry in the code-book 7 where said more reliable data M is stored. This way the low reliable data part or data parts L in the spectrogram are replaced by more reliable data parts M derived from a priori knowledge gained from training data included in the code-book 7. This method avoids correlation calculations, inversions of matrices and limitations as to the specific types of statistical, in particular Gaussian models. Any suitable method can be used to allocate reliability measures to spectrogram data by the reliability awarding means 8. For example a local Signal to Noise Ratio (SNR) provides an indication as to the reliability of the spectrogram data concerned. In a simple embodiment to be explained hereafter the well known gain function used in the well known spectral subtraction technique can be applied for indicating the reliability of the data.

FIG. 2 provides a more detailed explanation of the basic operation of the method in relation to the code-book 7. It shows a spectrogram S in the form of vector time frame data of successive frequency components indicated by circles in a frequency bin. Some spectrogram data L is determined to have a low reliability measure, and some other spectrogram data H is determined to have a high reliability measure, possibly but not necessarily after spectrally subtracting any disturbance therefrom. The code-book 7 comprises a succession of spectrogram data or vectors determined during a pre-recorded training session, generally based on speech or another input source. In each spectrogram frame that code-book entry is selected whose content H′ matches best with the reliable data H. Generally frequency component values and/or frequency component amplitudes are compared to find the best match. The entry thus selected in the code-book 7 also contains other spectrogram data, in particular one or more regions with the more reliable data M originating from the training session. Data M is used to replace data L so that the possibly weighted combination of spectrogram data M+H comprises the finally reconstructed spectrogram data having a better overall reliability. This leads to improved speech recognition results. Preferably the replacement is a gradual or weighted replacement. Such gradual replacement could depend on the reliability measure R_n ranging between 0 and 1, where n represents the index of frequency bin n. Indexed input and indexed output of the algorithm implementing the method may for example use the following rule:
Output_{—}n=R_{—}n*input_{—}n+(1−R_{—}n)*(best code-book match)_{—}n

It is possible not only to replace data L by data M, but also to replace spectrogram data H+L by H′+M, which is in particular advantageous in those cases where the training data comprises clean data, such as clean speech, which is virtually undisturbed.

Furthermore it is possible to process the more reliable data M such that it is influenced in dependence on known practical information on generally prior determined time and/or frequency behavior. This is schematically shown in FIG. 3 where the arrows indicate paths that may be followed during an influencing of the frequency/time behavior of at wish both the reliable data H/H′ and/or the replacing data M, such that given the reliable data and said behavior a more reliable estimate for data in the unreliable area results.

As explained above spectral subtraction is known per se from for example WO 97/45995, whose disclosure is incorporated here by reference thereto, where this technique is applied in a Dynamic Echo Suppressor (DES) or Dynamic Echo and Noise Suppressor (DENS). In the spectral subtraction process estimated or measured disturbances are subtracted from the original input disturbed signal. However when combining spectral subtraction with the method described above several advantages can be achieved. First the Signal to Noise Ratio (SNR) of the input spectrogram data will improve, resulting in an improved speech recognition rate. Secondly the gain function determined with spectral subtraction can be used to quantify the SNR and thus the reliability of the data concerned. For example the smaller the gain the lower the SNR. The limitation of spectral subtraction techniques is that these only take information into account which is local in time and frequency. So regions in the spectrogram highly corrupted by noise and/or echo can hardly be estimated sufficiently accurate. The present method supplements spectral subtraction by including a priori knowledge from the original generally more clean data of the code-book 7, in order to improve the spectrogram reconstruction and the recognition rate in case of speech.

Of course several further modifications and refinements are possible. One possible way of computing the nearest code-book entry concerns the measuring of a distance d² wherein more weight is assigned to more reliable data than to less reliable data. The following equation may be implemented:

$${d}^{2} = {\sum }_{n} {{G}_{n}^{2} ( {G}_{n} - {R}_{n} )}^{2}$$

where n is the frequency index of the frequency bin, Gₙ is the gain value of the spectral subtraction scheme, Cₙ is a code-book entry, and Rₙ either represents the noisy signal, or the signal after spectral subtraction, if the latter is used. Now that code-book entry is selected that minimizes the distance measure under the constraint that none of the components concerned is larger than the corresponding elements of the noisy spectral vector.

One other refinement concerns the computing of the final output signal in case the spectrogram data originates from the spectral subtraction. Depending on the SNR a weighing of the data M and H/H′ can be effected as well.

1. A method for reconstructing a disturbed spectrogram comprising spectrogram data, which is subjected to an awarding of a reliability measure, and whereof the spectrogram data having a low reliability measure is replaced by more reliable data, characterized in that the replacement is carried out by employing spectrogram data having a higher reliability measure as a means for selecting a code-book entry where said more reliable data is stored.

2. The method according to claim 1, characterized in that the selection of the code-book entry is based on a match between the spectrogram data having a higher reliability measure and the reliable spectrogram data stored in the code-book.

3. The method according to claim 1 or 2, characterized in that the replacement is a gradual replacement.

4. The method according to claim 3, characterized in that the gradual replacement dependents on the reliability measure.

5. The method according to one of the claims 1-4, characterized in that the spectrogram data stored in the code-book comprises data derived from training.

6. The method according to one of the claims 1-5, characterized in that the disturbed spectrogram is disturbed with noise, in particular additive noise such as background noise, and/or acoustic echo.

7. The method according to one of the claims 1-6, characterized in that the finally output reliable data is influenced in dependence on known information on its time and/or frequency behavior.

8. The method according to one of the claims 1-7, characterized in that the disturbed spectrogram is the result of a spectral subtraction process wherein estimated or measured disturbance is subtracted from an original disturbed signal.

9. A device for implementing the method according to one of the claims 1-8, the device comprising means for subjecting the spectrogram data to an awarding of a reliability measure, and means for replacing the spectrogram data having a low reliability measure by more reliable data, characterized in that the device further comprises code-book means coupled to both the subjecting means and the replacing means for carrying out the replacement by employing spectrogram data having a higher reliability measure as a means for selecting a code-book entry where said more reliable data is stored.

10. Signals suited for applying the method according to one of the claims 1-8 in a device according to claim 9.
